(19) United States
(12) Patent Application Publication
(10) Pub. No.: US 2006/0143260 A1
(43) Pub. Date: Jun. 29, 2006

(54) Low-power booth array multiplier with bypass circuits

(76) Inventors: Chuan-Cheng Peng, Hsinchu (TW); Wei-Bin Yang, Hsinchu (TW)

Correspondence Address: HARNESS, DICKEY & PIERCE, P.L.C., P.O. BOX 8910, RESTON, VA, 20195, US

(21) Appl. No.: 11/209,664

(22) Filed: Aug. 24, 2005

(30) Foreign Application Priority Data
Dec. 29, 2004 (TW) 93141246

(51) Int. Cl. G06F 7/52

(52) U.S. Cl. 708/620

(57) ABSTRACT

A low-power Booth array multiplier with bypass circuits is provided. The multiplier includes a first encoder for Booth-encoding the multiplier; a second encoder for pre-encoding the multiplier to generate an enabling signal and a plurality of control signals, wherein the control signals are used for determining whether to process partial product calculations or not; a selector for generating partial products according to the encoding results from the first encoder and the multiplicand; an adder array, which is composed of a plurality of adders for summing up the partial products. The adder includes a first multiplexer and a second multiplexer. When an adder of one row is disabled by the enabling signal, the first multiplexer receives a summation of the former row and the second multiplexer receives the carry bit of the former row. The multiplier further includes a plurality of third multiplexers for outputting the summation of the adder array.

This application claims the benefit of Taiwan Patent Application No. 93141246, filed on Dec. 29, 2004, which is hereby incorporated by reference for all purposes as if fully set forth herein.

### BACKGROUND OF THE INVENTION

1. Field of Invention

The invention relates to a multiplier and, more particularly, to a low-power Booth array multiplier with bypass circuits.

2. Related Art

Multiplication is a very complicated logical calculation; currently, a high-speed and low-power multiplier is usually implemented via Booth encoding. Since the Booth multiplier is able to deal with the 2 s complement and has low power dissipation, the Booth multiplier is generally used in the filed of digital signal processing (DSP). There are two advantages of Booth encoding before calculation: (1) decreasing the number of calculations for producing partial products; and (2) the partial products are always 0 when the encoded numbers are a series of 0 or 1.

The operation of the conventional Booth multiplier includes three steps: the first step, encoding a multiplier using Booth encoding; the second step, producing a correct partial product via a Booth selector according to the encoded result and a multiplicand; and the third step, summing up the partial products to obtain a final result.

The conventional Booth encoding method is shown in FIG. 1, which discloses a Booth array multiplier that utilizes the eight bits of X0˜X7 of a multiplicand multiplying the eight bits of Y0˜Y7 of a multiplier, and which includes a plurality of Booth encoders E, a plurality of selectors S1 and an array structure multiplier that is composed of an adder array, wherein the adder array includes full-adders (FAs) and half-adders (HAs).

Each Booth encoder E Booth encodes a multiplier in order to decrease the number of the partial product. It processes Booth encoding of the Y0˜Y7 bits of the multiplier and 0 to produce a selective signal, thereby outputting the encoding result to a selector S1. A selector 20 then processes a selection from the encoding result and the X0˜X7 bits of a multiplicand to produce a correct partial product. The major function of the selector 20 is to determine the result of the partial product base on the selective signal produced from the Booth encoder E, current bit and a former bit of the multiplicand. The adder array for summing up the partial products of a row and the summation of the former row is mainly composed of full-adders and half-adders. There are eight adders on each row of the adder array, so it sums up the partial products of each row and outputs a sum S and a carry bit C. Then, the next row sums up the output sum S and the carry bit C from the former row. There are sixteen adders on the last row, and it outputs the bits P0˜P15 after multiplication. S2 is an operator generation selector and SUB0˜SUB3 are carry bits for complement calculation.

FIG. 1 shows that after Booth encoding an eight-bit multiplier; it becomes a four-bit output. Therefore, it reduces the number of calculations. However, the conventional Booth encoder structure might have unnecessary power costs because if the Booth encoding result is 0, the partial product produced by the Booth selector must be zero too. However, the conventional method must process the above calculation no matter what the encoding result is, which increases the power consumption.

The power consumption is a critical design consideration in digital devices, so the unnecessary power cost on the Booth multiplier needs to be improved.

### SUMMARY OF THE INVENTION

In consideration of the abovementioned problems, the object of the invention is to provide a low-power Booth array multiplier that improves the problems of the conventional methods, decreases the power cost, and provides correct results.

To achieve this object, the invention provides a low-power Booth array multiplier with bypass circuits to process multiplication on a multiplier and a multiplicand. The multiplier includes a first encoder for encoding the multiplier using Booth encoding; a second encoder for pre-encoding the multiplier and producing an enabling signal and a plurality of control signals, wherein the control signals determine whether to process partial product calculations; a selector for producing partial products according to the encoding results produced from the first encoder and the multiplicand; an adder array, having a plurality of adders for summing up the partial products wherein the adder includes a first multiplexer and a second multiplexer, and when an adder of a some row is disabled the first multiplexer receives summation from the former row and the second multiplexer receives the carry bit from the former row; and a plurality of third multiplexers for outputting the summation of the adder array.

For comparison with the conventional encoder, the Booth encoder of the invention supplements a pre-encoder, and bypass circuits are provided within a Booth selector and an adder array. In order to determine whether the Booth encoder of each level processes encoding or keeps its original value, it pre-encodes a multiplier to determine the result if is zero, and the pre-encoder produces control signals which are needed by the bypass circuits to determine which level can skip calculations on the Booth encoder and on the adder array. Furthermore, if the encoding results are all zero, a last-degree multiplexer keeps all levels' encoding circuits still, thereby the final result of each bit is based on the carry bit of the former adder.

According to the first aspect of the invention, a Booth encoder with bypass circuits is provided that decreases calculation time by avoiding needless encoding, selecting and adding operations when the Booth pre-encoding result of a certain row is zero.

According to the second aspect of the invention, a Booth encoder with bypass circuits is provided that reduces the power consumption be avoiding needless calculations on circuits when the Booth pre-encoding result of a certain row is zero.

Further scope of applicability of the invention will become apparent from the detailed description given herein after. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The above and other objects, features and other advantages of the invention will be more clearly understood from the following detailed description when taken in conjunction with the accompanying drawings, in which:

FIG. 1 shows a block diagram according to a conventional Booth encoder.

FIGS. 2A˜2B shows block diagrams according to a multiplier array with bypass circuits of the invention.

FIG. 3 shows a block diagram according to an encoder with bypass circuits of the invention.

FIG. 4 shows a block diagram according to a row of a multiplier with bypass circuits of the invention.

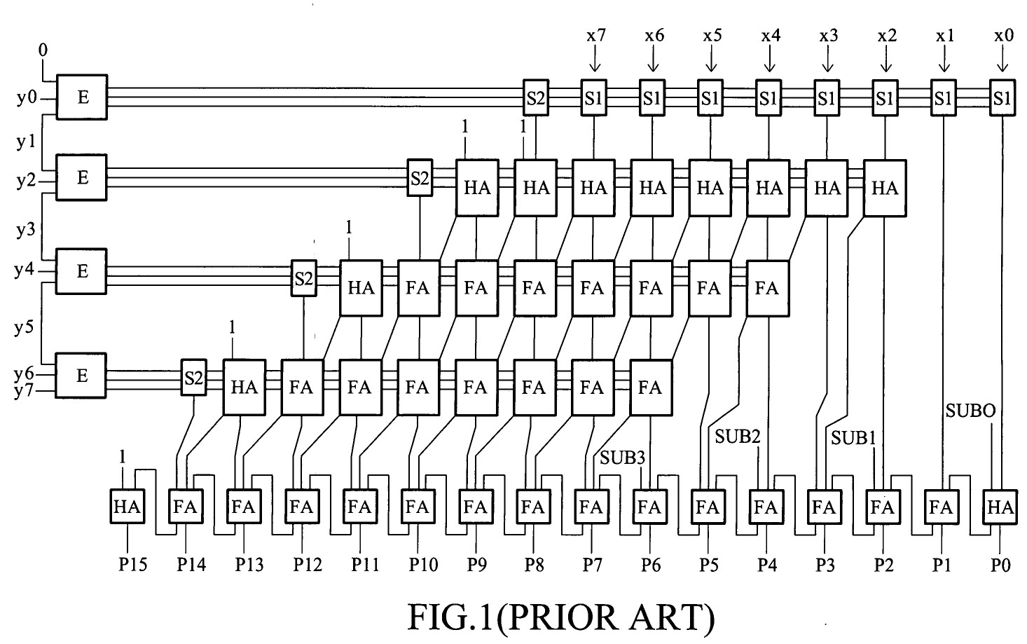

### DETAILED DESCRIPTION OF THE INVENTION

Reference will now be made in greater detail to a preferred embodiment of the invention, an example of which is illustrated in the accompanying drawings. Wherever possible, the same reference numerals are used throughout the drawings and the description to refer to the same or like parts. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

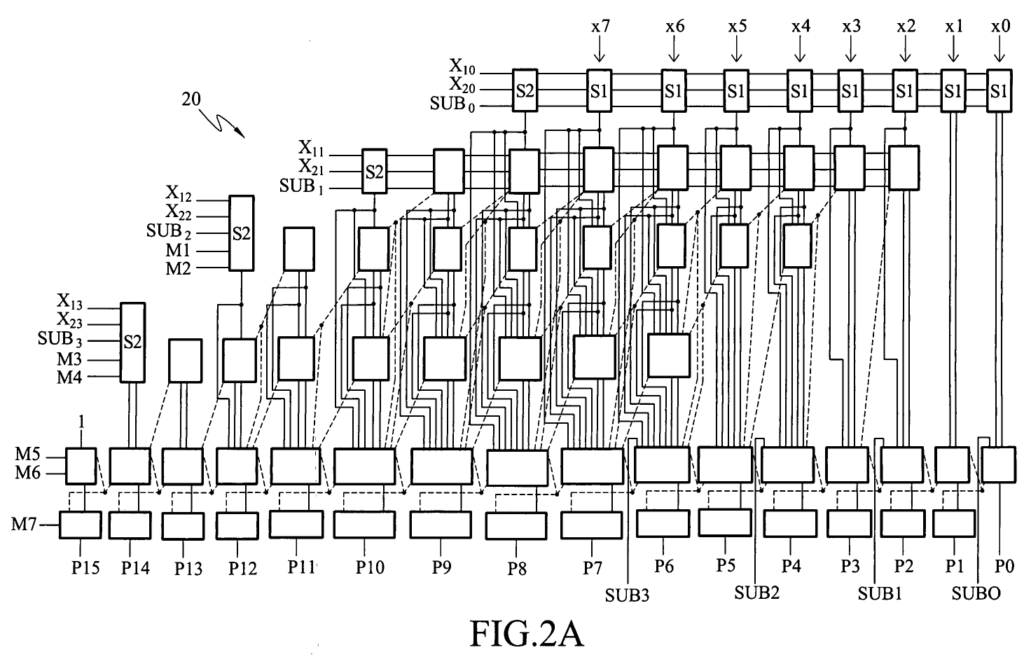

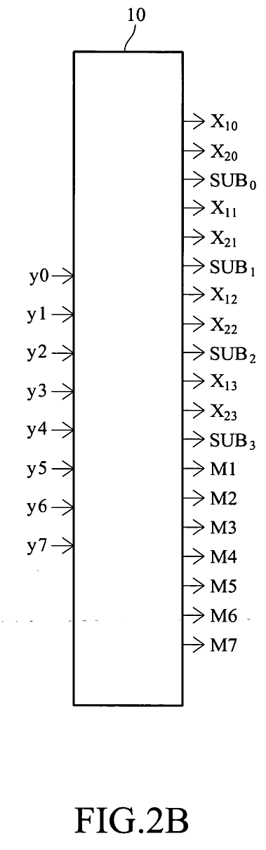

FIGS. 2A˜2B show block diagrams according to a Booth encoder with bypass circuits of the preferred embodiment of the invention, which includes an encoder 10, a selector S1 and an array multiplier that is composed of adder arrays 20. There are bypass circuits within the selector S1 and the adder array 20, and when the encoding result from the encoder 10 is zero, it stops the calculations on the adders of that row, thereby transferring the result of the former row to the next row. The dotted line on the diagram indicates that when the encoding result is zero, the result of the former row is transferred directly to the next row.

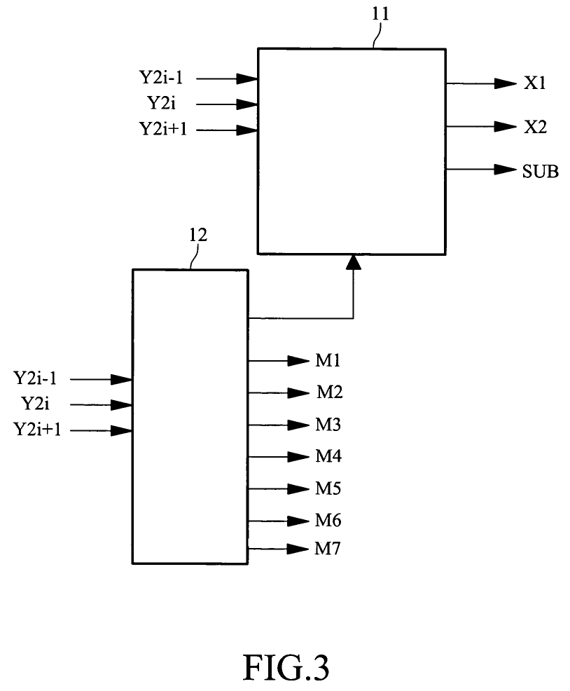

With reference to FIG. 3, the encoder 10 includes a first encoder 11 and a second encoder 12. The first encoder 11 is a Booth encoder for encoding a multiplier by a unit of three bits using Booth encoding, and generates a three-bit signal X1, X2, SUB. The second encoder 12 is for pre-encoding the multiplier by a unit of three bits to determine whether to process encoding or keep the result of the former encoding on each row of the adder array. In addition, the second encoder 12 generates control signals M1˜M7 that are needed by bypass circuits to determine which paths the partial products are to follow. The control signals M1˜M2 are used for controlling the adders of the first row on the adder array. The control signals M3˜M4 are used for controlling the adders of the second row. The control signals M5˜M6 are used for controlling the adders of the third row, and the control signal M7 is used for controlling the adders of the fourth row. Besides, the second encoder 12 generates an enabling signal to determine whether the first encoder 11 generates an encoding result based on the pre-encoding result. Therefore, when the output result from the second encoder 12 is zero, the first encoder 11 does not output an encoding result.

Each selector S1 and the adder array 20 both have a bypass circuit for determining whether to sum up the partial products from the selector S1 of a certain row or to sum up the summation result of the partial products from a certain row. It also outputs the calculation result from the selector S1 or from the adder array 20 according to the encoding result from the second encoder 12.

An adder array is composed of full-adders and half-adders, and it is known that there are two kinds of outputs from the adder: one is sum, and the other is carryout. An adder is called a full-adder if it has a carry input; otherwise, it is a half-adder. Therefore, the input for a half-adder only includes an addend and an augend, and the output includes a sum and a carry out.

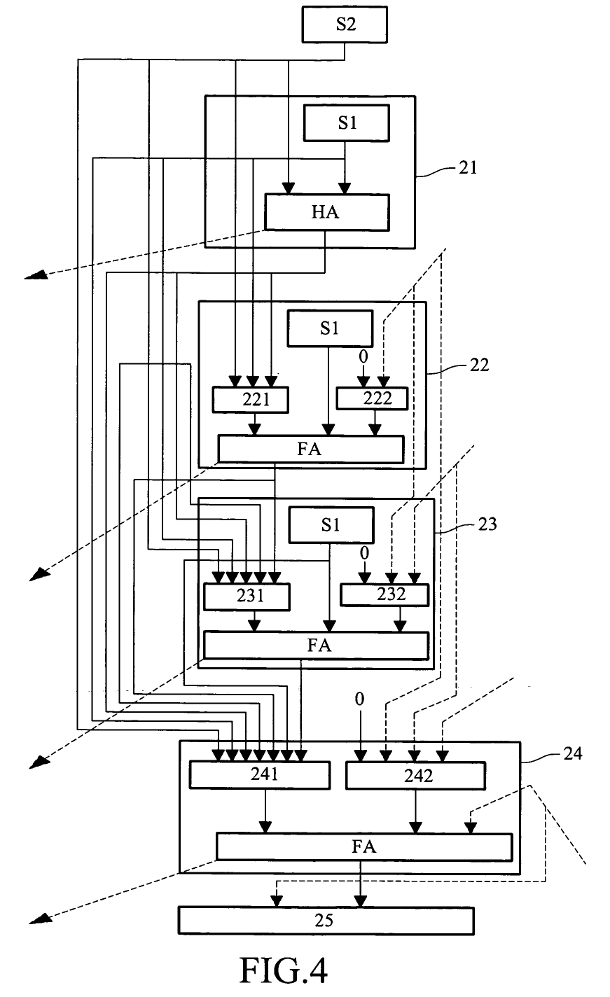

Detailed components of the selector S1 and the adder array 20 are shown in FIG. 4, which illustrates the structure of the circuits on a certain row (P8) of an array. When the pre-encoding results from all rows are zero, the array which is composed of the selectors S1 having the bypass circuits and the adder arrays 20 having the bypass circuits would not operate and the output is the former carry bit.

An adder of an adder array is implemented via multiplexers. Each adder includes a first multiplexer and a second multiplexer for directly outputting the former carry bit. If all the pre-encoding results from all rows are zero, the second encoder generates an enabling signal in order to keep the array still and output the former carry bit.

For example, the full-adder 22 includes a selector S1, a first multiplexer 221, a second multiplexer 222 and a full-adder (FA); the full-adder 23 includes a selector S1, a first multiplexer 231, a second multiplexer 232 and a full-adder (FA); the full-adder 24 includes a first multiplexer 241, a second multiplexer 242 and a full-adder (FA), wherein the first multiplexers 221, 231 and 241 are controlled by the control signals M1, M3 and M5, the second multiplexers 222, 232 and 242 are controlled by the control signals M2, M4 and M6, and the third multiplexer 25 is controlled by the control signal M7.

As shown in FIG. 4, when the full-adder 22 does not process a calculation, the full-adder 21 directly outputs the calculation result to the first multiplexer 231 of the full-adder 23, and the second multiplexer 232 accepts the carry bit.

The array multiplier with bypass circuits of the invention disables the Booth encoder of a certain row to make the inner circuits still. The Booth selector and the adder of the certain row also keep the former calculation value, thereby the former calculation result is directly transferred to the next row via the bypass circuits and added to the calculation result from the next row such that it can keep correct calculation results and decrease the power consumption by avoiding needless calculation.

In a summary, the hardware structure of the invention improves the problems of the conventional method; therefore, it decreases the power consumption during calculations and provides correct results.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A low-power Booth array multiplier with bypass circuits for processing multiplication on a multiplier and a multiplicand, comprising:
a first encoder for encoding the multiplier using Booth encoding;
a second encoder for pre-encoding the multiplier thereby producing an enabling signal and a plurality of control signals, wherein the control signals determines whether to process partial product calculations;
a selector for producing partial products according to the encoding results produced from the first encoder and the multiplicand;
an adder array, having a plurality of adders, for summing up the partial products, wherein the adder includes a first multiplexer and a second multiplexer, and when an adder of a some row is disabled, the first multiplexer receives summation from the former row, and the second multiplexer receives the carry bit from the former row; and
a plurality of third multiplexers for outputting the summation of the adder array.

2. The Booth array multiplier as claimed in claim 1, wherein the first encoder is a Booth encoder.

3. The Booth array multiplier as claimed in claim 1, wherein the adders further comprises a plurality of full-adders and a plurality of half-adders.
